(19) United States
(12) Patent Application Publication
(10) Pub. No.: US 2025/0282508 A1
(43) Pub. Date: Sep. 11, 2025

(54) METHOD FOR PRODUCING PRODUCTS CONTAINING A FOODSTUFF IN A SKIN

(71) Applicant: PEME SA, Quartino (CH)

(72) Inventor: Stefano Pedroia, Minusio (CH)

(73) Assignee: PEME SA, Quartino (CH)

(21) Appl. No.: 18/861,436

(22) PCT Filed: May 4, 2023
(86) PCT No.: PCT/EP2023/061756

§ 371 Date: Oct. 29, 2024

(30) Foreign Application Priority Data
May 4, 2022 (DE) 10 2022 110 969.0

(51) Int. Cl. B65B 9/12; A23L 23/00; B65B 25/00

(52) U.S. Cl. CPC B65B 9/12; A23L 23/00; B65B 25/001

(57) ABSTRACT

The invention relates to a method for producing a product (5.1-5.3) that contains a foodstuff in a skin (10) in one strand, successive products (5.1-5.3) being separated from one another by a tie-off region (3). According to the invention, a tensioned thread (4) is wound repeatedly around the tie-off region (3) along its length(S) and this thread can be run from product (5.1-5.3) to product (5.1-5.3).

### TECHNICAL FIELD

The invention relates to a method of producing products containing foodstuff in a skin in one strand and to a device therefor.

### PRIOR ART

The present invention relates to the production of food products in general. The focus here is primarily on liquid food products, such as soups. Up to now, these have been packaged in bags, for example, and placed in the microwave for preparation. The packaging of these foodstuffs requires a considerable amount of time.

Production methods that have so far been used to fill sausages on a strand cannot easily be applied to foodstuff in general, as most known methods create an area between the individual sausages that is secured by a metal clip. This means that these products cannot be reheated in the microwave.

Tie-off machines of the present type for sausages are known and commercially available in a variety of forms and designs. Reference is made in particular to EP 0 865 732 B1. In the tie-off machine described there, sausages are tied at a constant distance. A so-called double tying method is used. In double tying, two pairs of displacement tongs usually work together. The first pair is fixed, while the second pair is on a carriage so that it can move along the tie-off region. This carriage is moved by means of an actuating piston. The tie-off region is formed by two tie-off points, wherein after the first tie-off point has been created, a rotor for feeding the tie-off thread must be stopped until the sausage has been moved further in the conveying direction and it then creates the second tie-off point. Similar is shown in SU 435803 A1.

In EP 1 053 683 A2, the entire rotor housing is moved, creating a gap between two sausages. The axial movement is also performed by a pneumatic cylinder. During the axial movement of the rotor housing, the rotor is in turn stopped in its rotational movement.

This constant stopping and accelerating of the rotor causes a high level of wear, particularly on the drive belts, which impairs production reliability and increases running costs.

Another problem is that product residues remain between the first and second tie-off points in the tie-off region, which cause considerable hygiene problems after the sausages are cut off.

EP 3 545 768 A1 discloses a device and a method for tying-off a mass filled into a skin. This is effected on tie-off regions provided to this end by means of a thread. The device further comprises a rotor and a guide means for guiding the thread, wherein the rotor comprises a take-up portion for taking-up multiple windings of the thread. In this case, emphasis is on making tie-off points upstream and downstream a sausage, with the rotor being induced to rotate in different directions of rotation.

WO 2018/234520 A1 discloses a device for separating at least one sausage from another sausage, in particular from a sausage strand in the region of a tie-off region formed by two tie-off points between the sausage and the sausage strand. This tie-off region is associated with a cutting means. It is further disclosed that the sausage is firmly wound around with a thread, with the thread being guided over the entire sausage strand but is wound particularly strongly at the tie-off regions close to the sausage, so that the content located inside the sausage can not escape.

DE 601 03 357 T2, for example, discloses a tubular closed container for food packaging which comprises a plastic film which is tubular or sausage-shaped with overlapping, hot-melt edges. A non-hot-melt section remains, which forms a free edge of the upper film at the overlapping point, which is gripped to tear open the container in order to gain access to the inside of the container.

Furthermore, DE 1 604 580 C shows a method and a device for producing pouch packs closed on all sides from thermoplastic material for flowable material. In this method, a plastics tube filled with the flowable material is pressed in at appropriate intervals and the wall of the tube is pressed together along a line extending across the tube over a certain width and welded together to form a connecting point with a predetermined tear line.

### SUMMARY OF THE INVENTION

The object of the present invention is to eliminate the above-mentioned disadvantages and, in particular, to substantially accelerate the production of food products and to simplify the preparation of these food products.

Achieving the object is to wrap the tie-off region multiple times over its length with a taut thread and to continue this thread from product to product.

Filling machines for sausage meat in a sausage skin can also be used for filling any foodstuff into another skin for the production of this foodstuff on a strand. In particular, it is intended for filling soups, but the invention can be applied to any other flowable foodstuff.

Tying with a thread, for example a textile thread, has the significant advantage that the foodstuff, tied-off in the skin, can be placed in the microwave, for example, and heated there. In practice, it has been found that the tightly bound tie-off region between two products results in a sufficient seal. To use the foodstuff, the user then only has to grasp the string on the last product and pull on it so that the string untwists by itself and the product contents can be placed in a container, for example.

This thread is wound around the tie-off region in such a way that it displaces as much foodstuff as possible, which may be located between the two tie-off points, before the second tie-off point is created. This takes into account the significantly increased hygiene requirements.

According to the present invention, a thread is understood to mean any elongate element which can be wound around the tie-off region, regardless of the material and structure. It should also be within the scope of the present invention that making the tie-off points takes place separately from winding around the tie-off region. This could even be achieved by using different threads, but it is of course preferred within the scope of the present invention that the tie-off points and the wrapping of the tie-off region are carried out by the same thread and the same rotor.

Any possible and conceivable thread feeder is within the scope of the present invention. In most cases, this will be a rotor known from prior art, which winds the yarn around the tie-off points and the tie-off region. This thread feeder is accelerated to maximum speed at the first tie-off point and produces the first tie-off point by winding the yarn multiple times around the tie-off region. The product is then drawn further along the tie-off region in the conveying direction to produce a predetermined number of windings, at a speed that is synchronized with the speed of the thread feeder rotor so that a desired number of windings can be achieved. This can mean that the rotor always rotates at a constant high speed or that the speed is reduced slightly when the feed rate of the product is lower.

Preferably, all of this is carried out in conjunction with at least one, preferably two, displacers, wherein one displacer is usually stationary and a second displacer is movable or pulls the skin along at the start of the method and then an already finished product. The main function of the first, fixed displacer is to seal off the product before the first tie-off point and to displace the product mass towards the filling tube. To this end, the displacer comprises corresponding tongues or the like.

The second displacer encloses the tie-off region downstream the first tie-off point, which is also preferably done using appropriate tongs. It is then moved in the conveying direction of the strand downstream the first tie-off point has been created, catching the skin or the product created with it. This creates the tie-off region, wherein if the first displacer is preferably not completely closed, some foodstuff is already displaced from the tie-off region back towards the filling tube. When the first tie-off point is reached, the tie-off region is stopped again and the first tie-off point is created. Now the process starts all over again.

The carriage with the second displacer is preferably moved by a servo drive, i.e. a drive whose speed can be controlled, as is the case with an electric motor, for example. The servo drive can be accelerated, slowed down, stopped and accelerated again. How the movement is ultimately transferred to the carriage is of secondary importance; the invention covers both a spindle drive and a corresponding gearbox or linear drive. Such a servo drive enables the synchronization described below between the rotary movement of the rotor with the tie-off thread and the movement of the displacer.

What is essential to the present invention is that the synchronization between the movement of the rotor with the tie-off thread and the displacer movement is designed in such a way that a desired thread pitch can be generated between the two tie-off points without the rotor stopping and only then does the axial movement of the second displacer take place. There is also no stop between the first and second tie-off points, so that wear is reduced and therefore running costs can also be reduced. Furthermore, synchronization can be used to determine both the number of windings around the tie-off region and the degree to which the tie-off region is constricted by the winding.

The present invention also pays particular attention to the consideration of two important parameters, namely the skin type and the product quality. In particular, different strength values and elongation behavior of the skins must be taken into account. In a simple embodiment, a transparent film is envisaged, but all wrappings that are suitable for receiving foodstuff should be within the scope of the invention.

In the case of foodstuffs, the consistency, composition, etc. must of course be taken into account. According to the present invention, the speed of the axial movement of the displacer and also the acceleration of the rotor are to be determined and adapted for these parameters. The present invention provides that, for example, a camera is installed in the area of the skin intake on the rotor housing, which takes pictures of the skin and recognizes the skin type with the aid of artificial intelligence. The artificial intelligence can clearly assign objects by comparing images. The product quality can also be determined by the corresponding artificial intelligence. The detected skin type and product quality are used to make a basic setting for the speed, deceleration and acceleration of the machine for individual foodstuff and, if necessary, a tension that acts on the tie-off thread. These set values are then saved for each foodstuff and can be retrieved.

### BRIEF DESCRIPTION OF THE FIGURES

Further advantages, features and details of the invention can be taken from the following description of preferred exemplary embodiments and from the drawings, the drawings show in:

FIG. 1 a top view of three products in a product strand;

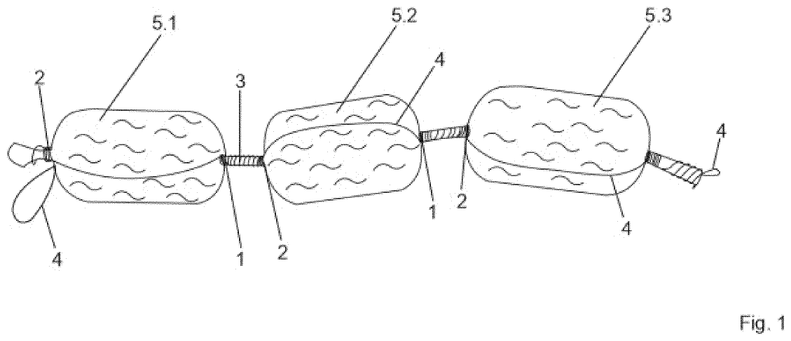

FIGS. 2 to 4 schematic representations of the generation of a tie-off region according to the present invention between products on one strand in different method stages.

### DETAILED DESCRIPTION

Foodstuff for products 5.1 to 5.3 is fed from a filling tube 7 into a skin 8, which is pushed onto the filling tube 7 in an accordion-like manner. The skin 8 is held in place on the filling tube 7 by brake lips 9. A bubble 10 containing foodstuff is formed in the skin 8 in front of the filling tube 7.

As a rule, two pairs of tong-like displacers 11 and 12 are also used to make the tie-off region. The front displacer 11 is stationary, while a rear, movable displacer 12 is mounted on a carriage, not shown in detail, on which it can be moved by means of a hydraulically or pneumatically actuated piston to create the tie-off region 3, wherein it carries the skin 8 at the start of production and subsequently also a product that has already been produced.

In the exemplary embodiment shown here, the closed tie-off region 3 is created by a first tie-off point 1 and a second tie-off point 2. This is done by means of a thread 4, which is wound around the tie-off region 3 by means of a rotor (not shown). This creates a firm constriction at the binding points 1 and 2 and also along the tie-off region 3.

The method flow is as follows:

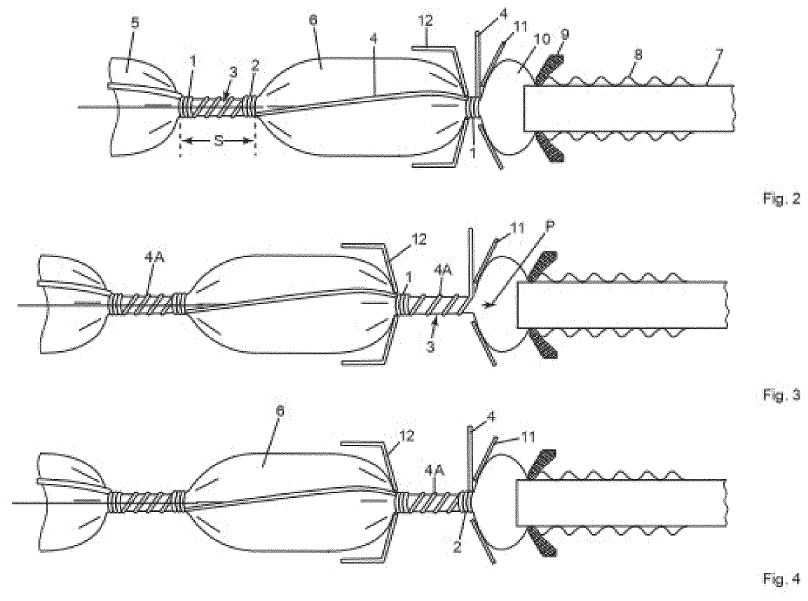

According to the present invention, the tie-off point 1 is now produced at maximum speed of the rotor and with tensioned thread 4, as shown in FIG. 2. The displacer 12 then moves away from the stationary displacer 11 according to FIG. 3, pulls the product along with it and forms the tie-off region 3, wherein foodstuff located in the tie-off region 3 is displaced into the bubble 10 by the closed tongs of the displacer 11 in the direction of the arrow P according to FIG. 3. This is preferably done while the wrapping speed of the rotor and the thread brake remain constant. In this way, the tie-off region is wound in a defined manner, which means that a predetermined number of windings 4A are placed around the tie-off region 3.

Then, according to FIG. 4, the second tie-off point 2 is made, preferably at a constant speed of the thread rotor, and the thread is slowed down so that the tension is maintained.

After the second tie-off point 2 has been created, the displacer 11 is opened and the product is pulled to the left by the displacer 12, for example, so that the filling tube 7 can fill the skin 8 with foodstuff for the next product. At the same time, the thread brake is opened so that no thread is wound around the newly formed product, but the thread is guided along this product. When the desired length of the product is reached, the displacer 11 is closed again, the displacer 12 is opened and returned to its initial position according to FIG. 2.

The second displacer 12 is moved on its carriage by a hydraulic or pneumatic cylinder. The stroke between two end positions corresponds approximately to the distance S. During this movement, the second displacer 12 catches the tip of the sausage skin 8 towards the first tie-off point 1 or the sausage in the conveying direction. All movements of the rotor for generating the tie-off points 1 and 2 as well as the tie-off region 3 and, if necessary, the movement(s) of the displacer(s) 11 and 12 are generated by servo drives, wherein both the rotor and the displacer can be accelerated or decelerated precisely. This means that, according to the invention, the rotor can always rotate at maximum speed when the two tie-off points 1 and 2 are generated and when the windings 4 A are made.

However, it is also conceivable that the first tie-off point 1 is made at the maximum speed of the rotor, then the rotor is moved along the tie-off region at a predetermined speed and possibly at a lower speed and only then is the rotor increased to maximum speed to produce the second tie-off point 2. The speed at which the rotor winds the tie-off thread around the tie-off region to make the tie-off points can be different from the speed at which the windings 4A are made along the tie-off region. When the second tie-off point 2 is reached, the rotor does not need to be stopped, only the winding speed is increased.

By synchronizing the rotor movement with the tie-off thread and the displacer movement along the tie-off region 3, the thread pitch between the two tie-off points 1 and 2 is determined in a targeted manner without the rotor stopping and only then does the axial movement of the second displacer along the tie-off point take place. This significantly reduces the need for the rotor to constantly stop and accelerate, resulting in considerably less wear and the associated running costs.

### LIST OF REFERENCE CHARACTERS

| | | | | |
|---|---|---|---|---|
| 1 | 1 st tie-off point | 34 | | |
| 2 | 2nd tie-off point | 35 | | |
| 3 | Tie-off region | 3 | | |
| 4 | Thread | 37 | | |
| 5 | Product | 38 | | |
| | | 39 | | |
| 7 | Filling pipe | 40 | | |
| 8 | Skin | 41 | | |
| 9 | Brake lip | 42 | | |
| 10 | Bubble | 43 | | |
| 11 | Displacer | 44 | | |
| 12 | Displacer | 45 | | |
| 13 | | 4 | | |
| 14 | | 47 | | |
| 15 | | 48 | | |
| 16 | | 49 | | |
| 17 | | 50 | 4A | Winding |
| 18 | | 51 | | |
| 19 | | 52 | | |
| 20 | | 53 | | |
| 21 | | 54 | | |
| 22 | | 55 | | |
| 23 | | 5 | P | Arrow |
| 24 | | 57 | | |
| 25 | | 58 | S | Length of 3 |
| 26 | | 59 | | |
| 27 | | 0 | | |
| 28 | | 1 | | |
| 29 | | 2 | | |
| 30 | | 3 | | |
| 31 | | 4 | | |
| 32 | | 5 | | |
| 33 | | | | |

1. Method for the production of a product (5.1-5.3) containing a foodstuff in a skin (10) on one strand, wherein successive products (5.1-5.3) are separated from one another by a tie-off region (3), created between two tie-off points (1, 2),
comprising
winding a tensioned thread (4) having a predetermined number of windings repeatedly around the tie-off region (3) along its length(S) in such a way, that it displaces as much foodstuff as possible, which is located between the tie-off points, before the second tie-off point is created, and this thread is run from product (5.1-5.3) to product (5.1-5.3).

2. Method according to claim 1, wherein the same thread (4) is used to make the tie-off points (1, 2) and to be wound around the tie-off region (3).

3. Method according to claim 1, wherein a thread feeder winds the thread (4) multiple times around the tie-off region (3) at the first tie-off point (1) of the tie-off region (3) to make the first tie-off point (1), then the product (5.1-5.3) is moved along its conveying direction to produce a predetermined number of windings (4A) and the second tie-off point (2) is made.

4. Method according to claim 3, wherein the speed is constant both during making of the tie-off points (1, 2) and during the wrapping of the tie-off region (3).

5. Method according to claim 3, wherein the wrapping speed of the thread feeder during making of the tie-off points (1, 2) is different from that during making of the windings (4A) around the tie-off region (3).

6. Method according to claim 1, wherein the skin (8) consists of plastic.

7. Method according to claim 1, wherein a transparent skin (8) is used.

8. Method according to claim 1, wherein a liquid foodstuff, in particular a soup, is selected as the foodstuff to be filled into the skin (8).

9. Method according to claim 1, wherein the tie-off region (3) is created by at least one displacer (11, 12).

10. Method according to claim 9, wherein a displacer (11) constricts the tie-off region (3) in the conveying direction upstream of the first tie-off point (1).

11. Method according to claim 10, wherein, downstream the first tie-off point (1), the product (5.1-5.3) is drawn further in the conveying direction by a further displacer (12) to create the tie-off region (3).

12. Method according to claim 11, wherein the tie-off region (3) is wound around as the product (5.1-5.3) continues to be drawn between the further displacer (12) and the first displacer (11).

13. Method according to claim 12, wherein the second tie-off point (2) is created upstream the first displacer (11).

14. Method according to claim 11, characterized in that wherein the movement of the further displacer (12) and the movement of the thread feeder are synchronized.

15. Method according to claim 1, wherein the skin type is determined and then the movement of thread feeder and/or displacers (11, 12) is determined.

16. Device for producing products (5.1-5.3) containing foodstuff in a skin on one strand, wherein successive products (5.1-5.3) are separated from one another by a tie-off region (3) and a rotor for a thread (4) for winding around the tie-off region (3) and a movable displacer (12) is assigned to the latter, wherein the movement of the displacer (12) synchronized with the movement of the rotor is effected by means of a servo drive.

17. Device according to claim 16, wherein the servo drive is an electric motor or linear drive.

18. Device according to claim 16, wherein a camera is provided for determining the skin type, which camera is in communication with an artificial intelligence.

19. Device according to claim 18, wherein the camera is arranged on the rotor housing in the region of a skin intake.

20. (canceled)

21. (canceled)

22. Method according to claim 8, wherein the liquid foodstuff is a soup.
